(19) United States
(12) Patent Application Publication
(10) Pub. No.: US 2026/0079490 A1
(43) Pub. Date: Mar. 19, 2026

(54) MOBILE OBJECT CONTROL DEVICE, METHOD OF CONTROLLING MOBILE OBJECT, AND STORAGE MEDIUM

(71) Applicant: HONDA MOTOR CO., LTD., Tokyo (JP)

(72) Inventors: Takahiko Hasegawa, Wako-shi (JP); Sango Matsuzaki, Wako-shi (JP)

(21) Appl. No.: 19/326,788

(22) Filed: Sep. 12, 2025

(30) Foreign Application Priority Data
Sep. 17, 2024 (JP) 2024-160322

(51) Int. Cl. G05D 1/229; G05D 1/243; G06T 7/11; G06T 7/73; G06V 10/14

(52) U.S. Cl. CPC G05D 1/229; G05D 1/243; G06T 7/11; G06T 7/73; G06V 10/14; G06T 2207/30261

(57) ABSTRACT

A mobile object control device includes: a recognition unit configured to estimate a self-position of a mobile object on the basis of a captured image including a surrounding situation of the mobile object and recognize a surrounding situation of the estimated self-position; a generation unit configured to generate a route from the mobile object to a destination on the basis of the recognized surrounding situation and the destination; and a control unit configured to control the mobile object so that the mobile object moves to the destination along the generated route, wherein the recognition unit estimates a shadow region including a shadow of a specific object in the captured image on the basis of the estimated self-position and a light source position, and masks a portion of the captured image on the basis of a position of the estimated shadow region.

### CROSS-REFERENCE TO RELATED APPLICATION

Priority is claimed on Japanese Patent Application No. 2024-160322, filed Sep. 17, 2024, the content of which is incorporated herein by reference.

### BACKGROUND OF THE INVENTION

### Field of the Invention

The present invention relates to a mobile object control device, a method of controlling a mobile object, and a storage medium.

### Description of Related Art

A technique of estimating the traveling position of a vehicle in consideration of the generation of shadows caused by sunlight is known (see, for example, the following Patent Document 1). A vehicle self-position estimation device disclosed in Patent Document 1 refers to map data to generate road pattern edge information which is information on the edges of road patterns, and captures an image of a vehicle in its traveling direction to generate external edge information which is edge information in the image. The vehicle self-position estimation device refers to the external edge information to detect locations where the edge branches into two, and generates predicted shadow pattern edge information which is information on the edges of a predicted shadow on the basis of the locations where the edge branches into two and the direction of sunlight. The vehicle self-position estimation device reduces the influence of shadow edges on position estimation by correcting the external edge information or the road pattern edge information using the predicted shadow pattern edge information.

[Patent Document 1] Japanese Unexamined Patent Application, First Publication No. 2015-102449

### SUMMARY OF THE INVENTION

However, since the vehicle self-position estimation device described above captures an image of a vehicle in its traveling direction to generate external edge information which is edge information in the image, it is necessary to generate external edge information for each frame of the image, detect locations where the edge branches into two, and generate predicted shadow pattern edge information. The vehicle self-position estimation device needs to correct the external edge information or road pattern edge information using the predicted shadow pattern edge information for each frame of the image. For this reason, the vehicle self-position estimation device has encountered a problem of increased processing load for estimating its self-position.

The present invention was contrived in view of such circumstances, and one object thereof is to provide a mobile object control device, a method of controlling a mobile object, and a storage medium that make it possible to reduce the processing load for reducing the influence of shadows included in a captured image.

In order to solve the above problem, the present invention adopts the following aspects.

(1) According to an aspect of the present invention, there is provided a mobile object control device including: a recognition unit configured to estimate a self-position of a mobile object on the basis of a captured image including a surrounding situation of the mobile object and recognize a surrounding situation of the estimated self-position; a generation unit configured to generate a route from the mobile object to a destination on the basis of the recognized surrounding situation and the destination; and a control unit configured to control the mobile object so that the mobile object moves to the destination along the generated route, wherein the recognition unit estimates a shadow region including a shadow of a specific object in the captured image on the basis of the estimated self-position and a light source position, and masks a portion of the captured image on the basis of a position of the estimated shadow region.

(2) In the aspect of the above (1), the specific object may be the mobile object, and the recognition unit may estimate the shadow region on the basis of the estimated self-position, the light source position, a shape of the mobile object, and a posture of a camera mounted on the mobile object.

(3): In the aspect of the above (1), the specific object may be a user whom the mobile object is guiding or following, and the recognition unit may estimate the shadow region on the basis of the estimated self-position, the light source position, a shape of the user, and a posture of a camera mounted on the mobile object.

(4) In the aspect of the above (1), the recognition unit may mask a portion of the captured image in a case where the mobile object is located outdoors.

(5) In the aspect of the above (1), the recognition unit may estimate an amount of movement of the mobile object on the basis of the captured image of which a portion is masked.

(6) The aspect of the above (1) may further include a map generation unit configured to generate map information on the basis of the captured image of which a portion is masked by the recognition unit, and the generation unit may generate the route on the basis of the map information generated by the map generation unit.

(7) In the aspect of the above (1), the recognition unit may estimate the self-position of the mobile object on the basis of the map information generated by the map generation unit and the captured image of which a portion is masked.

(8) According to an aspect of the present invention, there is provided a method of controlling a mobile object causing a computer to: estimate a self-position of a mobile object on the basis of a captured image including a surrounding situation of the mobile object and recognize a surrounding situation of the estimated self-position; generate a route from the mobile object to a destination on the basis of the recognized surrounding situation and the destination; control the mobile object so that the mobile object moves to the destination along the generated route; and estimate a shadow region including a shadow of a specific object in the captured image on the basis of the estimated self-position and a light source position, and mask a portion of the captured image on the basis of a position of the estimated shadow region.

(9) According to an aspect of the present invention, there is provided a computer readable non-transitory storage medium having a program stored therein, the program causing a computer to: estimate a self-position of a mobile object on the basis of a captured image including a surrounding situation of the mobile object and recognize a surrounding situation of the estimated self-position; generate a route from the mobile object to a destination on the basis of the recognized surrounding situation and the destination; control the mobile object so that the mobile object moves to the destination along the generated route; and estimate a shadow region including a shadow of a specific object in the captured image on the basis of the estimated self-position and a light source position, and mask a portion of the captured image on the basis of a position of the estimated shadow region.

According to the aspect of the present invention, it is possible to reduce the processing load for reducing the influence of shadows included in a captured image.

### BRIEF DESCRIPTION OF THE DRAWINGS

FIG. 1 is a diagram illustrating an example of a configuration of a mobile object system 1 including a mobile object 100.

FIG. 2 is a perspective view illustrating an example of the mobile object 100.

FIG. 3 is a block diagram illustrating an example of a functional configuration of the mobile object 100.

FIGS. 4A and 4B are diagrams illustrating masking in an embodiment, where FIG. 4A is a captured image and FIG. 4B is a masked captured image.

FIG. 5 is another diagram illustrating masking in the embodiment, and illustrating a state in which the mobile object 100 is following a user.

FIG. 6 is a flowchart illustrating an example of a processing procedure of a control device 200 in the embodiment.

### DETAILED DESCRIPTION OF THE INVENTION

Hereinafter, an embodiment of a mobile object control device of the present invention, a method of controlling a mobile object, and a storage medium will be described with reference to the accompanying drawings.

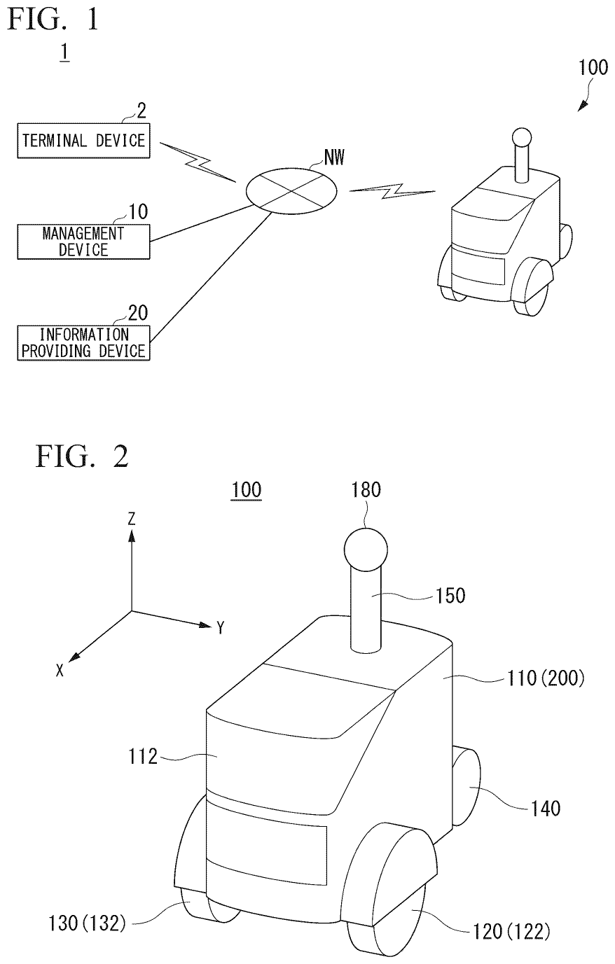

FIG. 1 is a diagram illustrating an example of a configuration of a mobile object system 1 including a mobile object 100.

The mobile object system 1 includes, for example, one or more terminal devices 2, a management device 10, an information providing device 20, and one or more mobile objects 100. These components communicate with each other, for example, through a network NW. The network NW is any network such as, for example, a LAN, a WAN, or an Internet line.

### Terminal Device

The terminal device 2 is a computer device such as, for example, a smartphone or a tablet terminal. The terminal device 2, for example, requests the management device 10 to provide authorization for use of the mobile object 100 on the basis of a user's operation, or acquires information indicating that use has been permitted.

### Management Device

In response to a request received from the terminal device 2, the management device 10 grants the authorization for use of the mobile object 100 to a user of the terminal device 2, or manages a reservation for use of the mobile object 100. The management device 10 generates and manages, for example, schedule information in which user identification information registered in advance and the date and time of the reservation for use of the mobile object 100 are associated with each other.

### Information Providing Device

The information providing device 20 provides the mobile object 100 with a position at which the mobile object 100 is present, a region through which the mobile object 100 moves, and map information on the surrounding region. In response to a request received from the mobile object 100, the information providing device 20 may generate a route to the destination of the mobile object 100, and provide the generated route to the mobile object 100.

### Mobile Object

The mobile object 100 is disposed at a predetermined position in a facility or a town. When a user wants to use the mobile object 100, the user can start using the mobile object 100 by operating its operating unit (not shown), or start using the mobile object 100 by operating the terminal device 2. For example, when a user goes shopping and has a lot of baggage, the user starts using the mobile object 100 and puts the baggage into the storage compartment of the mobile object 100. The mobile object 100 then moves together with the user so as to autonomously follow the user. With the baggage stored in the mobile object 100, the user can continue shopping or head to the next destination. For example, the mobile object 100 moves while moving on a sidewalk or a crosswalk on a roadway together with a user. The mobile object 100 can move in regions through which pedestrians can pass, such as a roadway and a sidewalk. For example, the mobile object 100 may be used in indoor or outdoor facilities or private lands, such as a shopping center, an airport, a park, or a theme park, and can move in regions through which pedestrian can pass.

The mobile object 100 may be capable of moving autonomously in a mode such as a guidance mode or an emergency mode in addition to (or instead of) the following mode in which it follows a user as described above.

The guidance mode is a mode in which a user is guided to a destination designated by the user, and the user is guided by moving autonomously in front of the user in accordance with the user's movement speed. For example, when a user is looking for a predetermined commercial product in a shopping center, and the user requests the mobile object 100 to guide him or her to the location of predetermined commercial product, the mobile object 100 guides the user to the location of the commercial product. This makes it possible for the user to easily find a predetermined commercial product. In a case where the mobile object 100 is used in a shopping center, the mobile object 100 or the information providing device 20 holds information in which the locations of commercial products, the locations of stores, the locations of facilities within a shopping center, and the like are associated with map information, as well as map information of the shopping center. This map information includes detailed map information including the widths of roads or passageways, and the like. The locations of commercial products, the locations of stores, the locations of facilities within a shopping center, and the like may also be included in the map information. In a case where a control device 200 stores map information 222 as will be described later, the mobile object 100 or the information providing device 20 does not need to hold the map information of the shopping center or the like.

The guidance mode may be a mode in which a user is guided to a destination estimated on the basis of information such as map information and the user's actions (including orientation, speed, behavior, and the like) even if the user does not designate a destination. For example, the mobile object 100 or the information providing device 20 may detect the orientation of the user from an image captured by a camera 180 to be described later, set a straight line representing the detected orientation of the user, and estimate, as a destination, a location that intersects the straight line or a location which is closest to it among locations registered in the map information. For example, the mobile object 100 or the information providing device 20 may register a plurality of gestures (such as, for example, a gesture of drinking a drink and a gesture of charging a mobile phone) in advance, collate the behavior of the user detected from an image with the registered gesture, and estimate, as a destination, a location that satisfies the requirements of the gesture (such as, for example, a restaurant or a rechargeable facility) among the locations stored in the map information. For example, the mobile object 100 or the information providing device 20 may estimate, as a destination, a location that has been most frequently set as a destination by a user in the past among the facilities stored in the map information.

The emergency mode is a mode in which, in a case where something unusual happens a user while moving with the user (for example, a case where the user falls), autonomous movement is performed to seek help from nearby people or nearby facilities in order to help the user. In addition to (or instead of) following and guiding as described above, the mobile object 100 may move while maintaining a moderate (neither too close nor too far) distance from the user.

The mobile object 100 is not limited to the above, and may be any object that a user can ride in, or may be, for example, a vehicle. The vehicle may be not only a four-wheeled vehicle, but also any vehicle that can move with three or two wheels. The vehicle may be capable of traveling on both a roadway and a sidewalk with a user on board.

FIG. 2 is a perspective view illustrating an example of the mobile object 100.

In the following description, the forward direction of the mobile object 100 is defined as a +x direction, the rearward direction of the mobile object 100 is defined as a −x direction, the leftward direction in the widthwise direction of the mobile object 100 with respect to the +x direction is defined as a +y direction, the rightward direction is defined as a −y direction, and the direction orthogonal to the x direction and the y direction, which is the height direction of the mobile object 100, is defined as a +z direction.

The mobile object 100 includes, for example, a base body 110, a door portion 112 provided on the base body 110, and wheels (a first wheel 120, a second wheel 130, and a third wheel 140) assembled to the base body 110. For example, a user can open the door portion 112 to put baggage into a storage compartment provided in the base body 110 or extract the baggage from the storage compartment. The first wheel 120 and the second wheel 130 are driving wheels, and the third wheel 140 is an auxiliary wheel (driven wheel). The mobile object 100 may be capable of moving using a configuration other than wheels, such as a caterpillar.

A cylindrical support 150 extending in the +z direction is provided on the surface of the base body 110 in the +z direction. The camera 180 that captures images of the vicinity of the mobile object 100 is provided on the end of the support 150 in the +z direction. The position at which the camera 180 is provided may be any position different from the above.

The camera 180 is, for example, a camera capable of capturing images of the vicinity of the mobile object 100 at a wide angle (for example, 360 degrees). The camera 180 may include a plurality of cameras. The camera 180 may be realized by a combination of, for example, a plurality of 120-degree cameras or a plurality of 60-degree cameras.

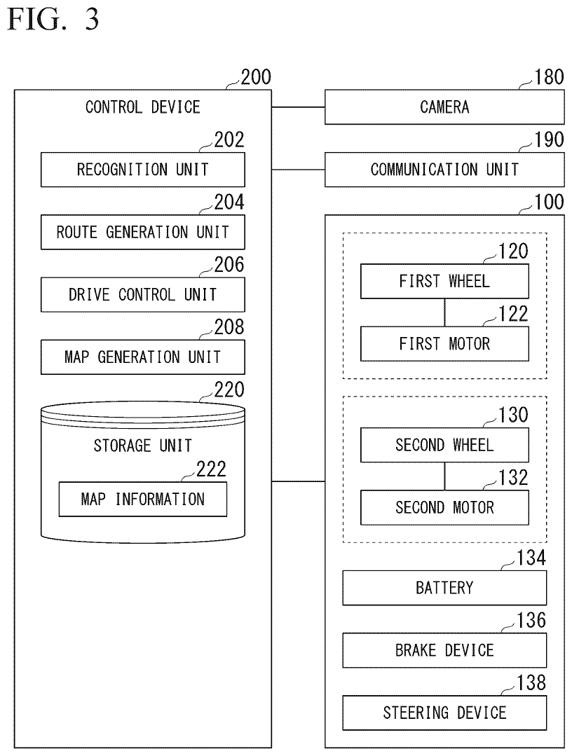

FIG. 3 is a block diagram illustrating an example of a functional configuration the mobile object 100.

In addition to the functional configuration shown in FIG. 2, the mobile object 100 includes a first motor 122, a second motor 132, a battery 134, a brake device 136, a steering device 138, a communication unit 190, and the control device 200. The first motor 122 and the second motor 132 are operated by electric power supplied from the battery 134. The first motor 122 drives the first wheel 120. The second motor 132 drives the second wheel 130. The first motor 122 may be an in-wheel motor provided on the wheel of the first wheel 120. The second motor 132 may be an in-wheel motor provided on the wheel of the second wheel 130.

The brake device 136 outputs a brake torque to each of the first wheel 120 and the second wheel 130 on the basis of an instruction from the control device 200. The steering device 138 includes an electric motor. The electric motor, for example, changes the direction of the first wheel 120 or the second wheel 130 by causing a force to act on a rack and pinion mechanism on the basis of the instruction from the control device 200 to change the course of the mobile object 100.

The communication unit 190 is a communication interface for communicating with the terminal device 2, the management device 10, or the information providing device 20.

### Control Device

The control device 200 includes, for example, a recognition unit 202, a route generation unit 204, a drive control unit 206, a map generation unit 208, and a storage unit 220. The recognition unit 202, the route generation unit 204, the drive control unit 206, and the map generation unit 208 are realized by, a hardware processor such as, for example, a central processing unit (CPU) executing a program (software). Some or all of these components may be realized by hardware (a circuit unit; including circuitry) such as a large scale integration (LSI), an application specific integrated circuit (ASIC), a field-programmable gate array (FPGA), or a graphics processing unit (GPU), and may be realized by software and hardware in cooperation. The program may be stored in a storage device such as a hard disk drive (HDD) or a flash memory (a storage device including a non-transitory storage medium) in advance, may be stored in a detachable storage medium such as a DVD or a CD-ROM (non-transitory storage medium), or may be installed by the storage medium being installed in a drive device.

The storage unit 220 is realized by a storage device such as a HDD, a flash memory, or a random access memory (RAM). The storage unit 220 stores the map information 222 which is referenced by the mobile object 100. The map information 222 is, for example, information indicating a map of the position at which the mobile object 100 is present, the region in which the mobile object 100 moves, the vicinity of the region, or the like provided by the information providing device 20. The map information 222 is, for example, information in which feature points included in a captured image generated by the camera 180 and position information are associated with each other. The captured image captured by the camera 180 includes both a captured image including a shadow of a specific object and a captured image not including a shadow of a specific object. The specific object is the mobile object 100 or a user. The captured image including the shadow of a specific object is an image that has undergone masking as will be described later.

The map information 222 may be, for example, information including the positions of walls, obstacles, and the like detected by light detection and ranging (LiDAR). The map information 222 may be information in which features included in an image, information indicating objects such as walls and obstacles detected by LiDAR, and position information are associated with each other. The information detected by LiDAR may include a user as a specific object. The region corresponding to the user in the information detected by LiDAR may be masked.

A portion of or all of the functional configuration included in the control device 200 may be included in another device. For example, the other device and the mobile object 100 may communicate with each other and cooperate to control the mobile object 100.

The recognition unit 202 estimates the self-position of the mobile object 100 on the basis of the captured image including the surrounding situation of the mobile object 100, and recognizes the surrounding situation of the estimated self-position. The self-position of the mobile object 100 is a position in a map included in the map information 222, and may be information indicating, for example, latitude and longitude. The recognition unit 202 estimates a shadow region including a shadow of a specific object in the captured image on the basis of the estimated self-position and a light source position, and masks a portion of the captured image on the basis of the position of the estimated shadow region. The light source position is the position of a light source present in the vicinity of the mobile object 100, that is, the position of a light source at which a shadow of the mobile object 100 or the user is formed. The light source is the sun outdoors or lighting indoors.

Specifically, the recognition unit 202 recognizes the positions of objects present in the vicinity of the mobile object 100 (distance from the mobile object 100 and direction relative to the mobile object 100) and states such as the speed and acceleration thereof on the basis of images captured by the camera 180. The objects include traffic participants, obstacles present in facilities or on roads, and the like. The recognition unit 202 recognizes and tracks the user of the mobile object 100. For example, the recognition unit 202 tracks the user on the basis of an image obtained by capturing an image of the user (for example, a facial image of the user) registered when the user uses the mobile object 100, or a facial image of the user (or feature amount obtained from the facial image of the user) provided by the terminal device 2 or the management device 10. The recognition unit 202 recognizes a gesture performed by the user. The mobile object 100 may be provided with a detection unit different from a camera such as a radar device or LiDAR. In this case, the recognition unit 202 recognizes the situation around the mobile object 100 using the detection results of a radar device or LiDAR instead of (or in addition to) images.

The map generation unit 208 generates map data on the basis of feature points detected from the captured image generated by the camera 180. The map data is data in which the self-position estimated by the recognition unit 202 and the feature points are associated with each other. The map generation unit 208 stores the generated map data in the storage unit 220. The storage unit 220 updates the map information 222 by registering data including the captured image and the feature point at positions included in the map data.

The map generation unit 208 may generate the map information 222 on the basis of the captured image of which a portion is masked by the recognition unit 202. The captured image of which a portion is masked by the recognition unit 202 is an image in which the shadow of a specific portion is covered with a mask image.

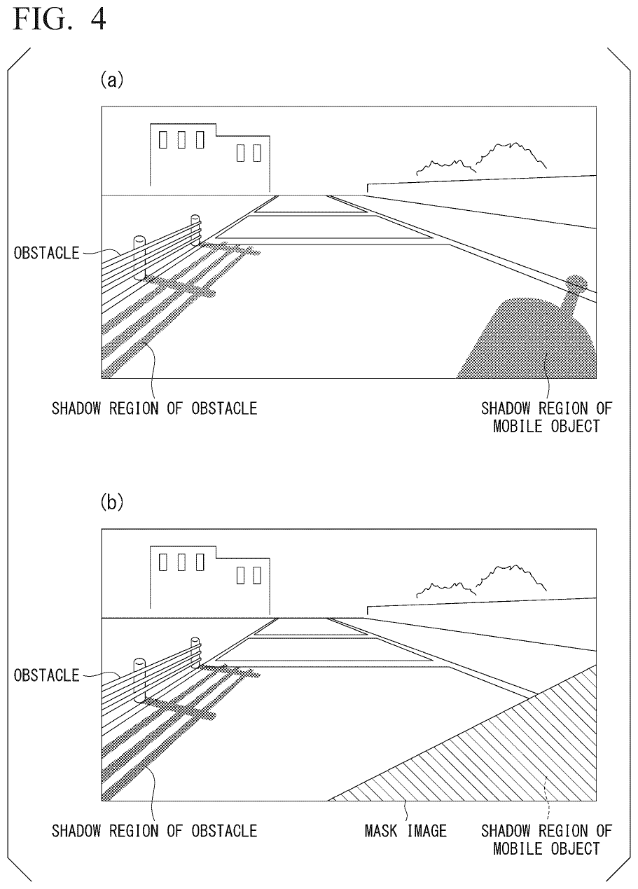

FIGS. 4A and 4B are diagrams illustrating masking in the embodiment, wherein FIG. 4A is a captured image and FIG. 4B is a masked captured image.

The captured image shown in FIG. 4A includes a shadow region representing the shadow of the mobile object 100. The captured image shown in FIG. 4A includes a shadow region representing an obstacle, such as a fence, present around the mobile object 100 and the shadow of the obstacle.

The recognition unit 202 estimates the self-position, and estimates a shadow region including the shadow of a specific object in the captured image on the basis of the estimated self-position and the light source position. In the example of FIGS. 4A and 4B, the shadow region in the captured image is estimated by estimating that the sun is behind the mobile object 100 and the shadow of the mobile object 100 appears in front of the mobile object 100. The recognition unit 202 superimposes a mask image as shown in FIG. 4B on the estimated shadow region. Thereby, the shadow region of the mobile object 100 included in the captured image is covered with the mask image. The masked captured image is used by the map generation unit 208 to generate map data.

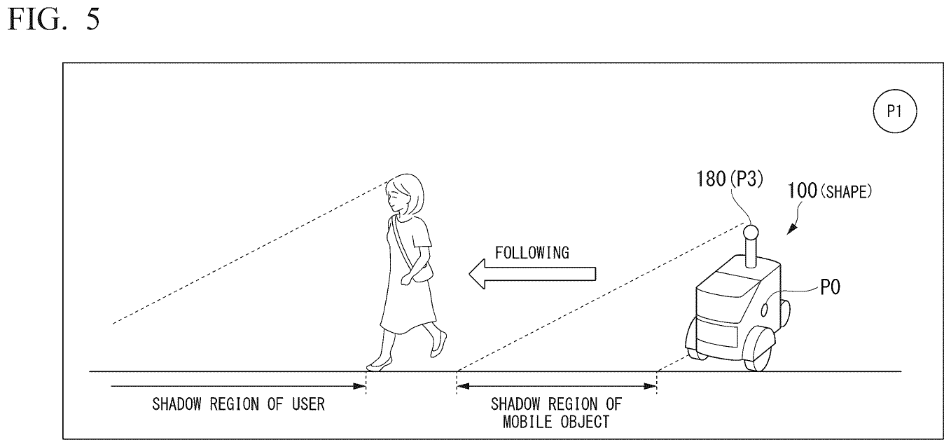

FIG. 5 is another diagram illustrating masking in the embodiment, that is, a diagram illustrating a state in which the mobile object 100 is following a user.

The recognition unit 202 estimates the shadow region of the mobile object 100 on the basis of the estimated self-position P0 of the mobile object 100, the light source position P1, the shape of the mobile object 100, and the posture of the camera 180 mounted on the mobile object 100. For example, in a case where the light source is the sun, the light source position P1 is calculated from latitude longitude information based on the self-position P0 of the mobile object 100 and time information. For example, in a case where the light source is a lighting fixture, the light source position P1 is acquired from the position of the lighting fixture included in the map information 222. The shape of the mobile object 100 is, for example, the outer shape of the mobile object 100, such as the height and width of the mobile object 100. The information indicating the shape of the mobile object 100 is information stored in advance in the storage unit 220 or the like. The posture of the camera 180 is the orientation of the camera 180 with respect to the front of the mobile object 100, and corresponds to the imaging direction of the camera 180.

The recognition unit 202 estimates the shadow region on the basis of the estimated self-position P0 of the mobile object 100, the light source position P1, the shape of the user whom the mobile object 100 is guiding or following, and the posture of the camera mounted on the mobile object 100. The shape of the user is, for example, the outer shape of the user, such as the height and width of the user.

The recognition unit 202 may perform masking using a machine learning model. For example, the machine learning model is trained using learning data such as the shape of the mobile object 100 or the user, the time, the position of the sun, the position of the mobile object 100 or the user, and a shadow region in the captured image. The recognition unit 202 can input information such as the shape of the mobile object 100 or the user, the position of the mobile object 100 or the user, the time, the position of the sun, and the captured image into the machine learning model, and perform masking on the captured image on the basis of the information indicating the shadow region output from the machine learning model.

The route generation unit 204 generates a route from the mobile object 100 to the destination on the basis of the recognized surrounding situation and the destination. The destination indicates the user itself to be followed or a point within a predetermined range from the user in a case where the mobile object 100 is in following mode. For example, the route generation unit 204 may set a predetermined point diagonally behind the user as the destination so that the mobile object 100 can follow the user and be visible to the user. For example, the route generation unit 204 may determine a destination so that a distance from the user is maintained within a predetermined range on the basis of the walking speed of the user in order to prevent the destination from becoming too far away from the user. In the case of being in the guidance mode, for example, the location of a commercial product or a facility set by the user is displayed. In this case, the user designates the location of a commercial product or a facility, and the mobile object 100 collates the designated location of the commercial product or the facility with the map information 222, and sets the specified location of the commercial product or the facility as the destination as a result of the collation. In the case of being in the guidance mode, if the point set by the user is far from the current location of the mobile object 100, the route generation unit 204 may set the point set by the user as a final destination, and set a point within a predetermined range from the current location as a temporary destination.

In the guidance mode, the user does not necessarily have to set a destination, and the mobile object 100 may predict the direction in which the user moves and move autonomously in front of the user in accordance with the movement speed of the user. In this case, the route generation unit 204 may set the destination of the mobile object 100 as a point within a predetermined range in front of the user.

The route is a route that allows the mobile object 100 to reasonably reach the destination in consideration of the forward direction of the mobile object 100 (that is, the x direction of the mobile object 100). The route generation unit 204 generates a plurality of waypoints for reaching the destination from the current location, and generates a route by connecting the plurality of waypoints. The route generation unit 204 obtains, for example, the risk for each waypoint, and in a case where the obtained risk satisfies a criterion set in advance (for example, in a case where the risk of each waypoint is equal to or less than a threshold Th1) or in a case where the total value the obtained risks satisfies a criterion set in advance (for example, in a case where the total value of the risks is equal to or less than a threshold Th2), the route that satisfies the criterion is adopted as a target route along which the mobile object 100 is to move. Here, the risk indicates that the larger the value, the more the mobile object 100 should not enter or approach, and the closer the value is to zero, the more favorable it is for the mobile object 100 to pass through. Therefore, in general, as the distance to the position of a recognized object decreases, the value of the risk increases, whereas as the distance from the position of the recognized object increases, the value of the risk decreases.

The drive control unit 206 controls the motors (the first motor 122 and the second motor 132), the brake device 136, and the steering device 138 so that the mobile object 100 travels along the route generated by the route generation unit 204.

### Processing Procedure

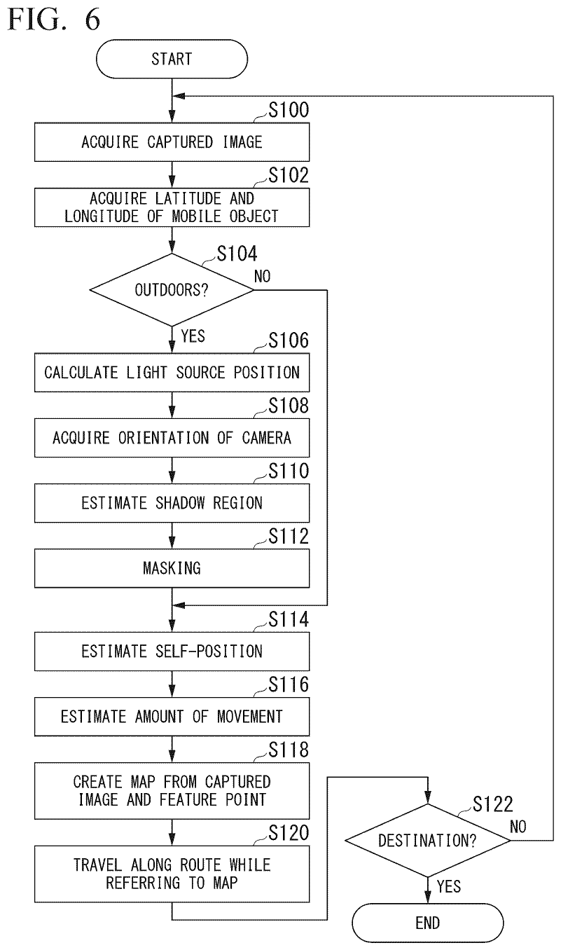

FIG. 6 is a flowchart illustrating an example of a processing procedure of the control device 200 in the embodiment. The process shown in FIG. 6 is executed while the mobile object 100 is traveling in the following mode or the guidance mode.

The recognition unit 202 acquires a captured image obtained by capturing an image of the surrounding situation of the mobile object 100 (step S100). Next, the recognition unit 202 acquires information indicating the latitude and longitude of the mobile object 100 (step S102). The recognition unit 202 may acquire the self-position estimated in the previous process in a case where recognition unit 202 is repeatedly estimating the self-position, or may acquire a position based on a GPS signal. The recognition unit 202 determines whether the mobile object 100 is traveling outdoors (step S104). In a case where the mobile object 100 is not traveling outdoors (step S104: NO), the recognition unit 202 advances the process to step S114 and the subsequent steps.

In a case where the mobile object 100 is traveling outdoors (step S104: YES), the recognition unit 202 calculates the light source position (step S106). Specifically, the recognition unit 202 calculates the position of the sun relative to the mobile object 100 from the self-position and the time. The recognition unit 202 acquires information indicating the orientation of the camera 180 from the mobile object 100 (step S108). The recognition unit 202 estimates the shadow region in the captured image captured by the camera 180 from the self-position of the mobile object 100, the position of the sun, and the orientation of the camera 180 (step S110). The recognition unit 202 performs masking on the shadow region by generating a masking image of a size enough to cover at least a portion of the estimated shadow region and superimposing the masking image on the shadow region (step S112).

In step S114, the recognition unit 202 estimates the self-position using the captured image acquired in step S100 or the captured image that has undergone masking in step S112. In this case, the recognition unit 202 collates the feature points extracted from the captured image acquired in step S100 or the captured image that has undergone masking in step S112 with the feature points of the map included in the map information 222, and determines that the mobile object 100 is present at the position on the map where the feature points are collated. Next, the recognition unit 202 estimates the amount of movement of the mobile object 100 on the basis of the estimated self-position and the self-position estimated in the previous process (step S116).

The map generation unit 208 generates map information on the basis of the captured image acquired in step S100 or the captured image of which a portion is masked by the recognition unit 202 (step S118). The map generation unit 208 may update the map information 222 by adding the feature points in the captured image acquired at the position of the mobile object 100 estimated by the recognition unit 202 to the map information 222.

The drive control unit 206 causes the mobile object 100 to travel along the route while referring to the map information 222 (step S120). The control device 200 determines whether the mobile object 100 has reached the destination (step S122), and ends the process of this flowchart in a case where the mobile object 100 has reached the destination (step S122: YES). In a case where the mobile object 100 has not reached the destination (step S122: NO), the control device 200 repeats step S100 and the subsequent steps.

As described above, according to the control device 200 of the mobile object 100 of the embodiment, the recognition unit 202 can estimate the shadow region including the shadow of a specific object in the captured image on the basis of the estimated self-position and the light source position, and mask a portion of the captured image on the basis of the position of the estimated shadow region. Thereby, according to the control device 200, it is possible to suppress the extraction of the shadow of the mobile object 100 or the user included in the captured image as a feature point. According to the control device 200, it is possible to improve the estimation accuracy for the self-position of the mobile object 100. According to the control device 200, it is possible to prevent the shadow of the mobile object 100 or the user from being registered in the map information 222 as a feature point. According to the control device 200, the shadow region in a captured image can be masked without performing image processing on the captured image, and thus it is possible to reduce the processing load for reducing the influence of shadows included in a captured image.

The above-described embodiment can be represented as follows.

A mobile object control device including:
a storage medium having computer-readable instructions stored therein; and
a processor connected to the storage medium,
wherein the processor executes the computer-readable instructions to
estimate a self-position of a mobile object on the basis of a captured image including a surrounding situation of the mobile object and recognize a surrounding situation of the estimated self-position,
generate a route from the mobile object to a destination on the basis of the recognized surrounding situation and the destination, control the mobile object so that the mobile object moves to the destination along the generated route, and
estimate a shadow region including a shadow of a specific object in the captured image on the basis of the estimated self-position and a light source position, and mask a portion of the captured image on the basis of a position of the estimated shadow region.

While preferred embodiments of the invention have been described and illustrated above, it should be understood that these are exemplary of the invention and are not to be considered as limiting. Additions, omissions, substitutions, and other modifications can be made without departing from the spirit or scope of the present invention. Accordingly, the invention is not to be considered as being limited by the foregoing description, and is only limited by the scope of the appended claims.

What is claimed is:

1. A mobile object control device comprising:
a recognition unit configured to estimate a self-position of a mobile object on the basis of a captured image including a surrounding situation of the mobile object and recognize a surrounding situation of the estimated self-position;
a generation unit configured to generate a route from the mobile object to a destination on the basis of the recognized surrounding situation and the destination; and
a control unit configured to control the mobile object so that the mobile object moves to the destination along the generated route,
wherein the recognition unit estimates a shadow region including a shadow of a specific object in the captured image on the basis of the estimated self-position and a light source position, and masks a portion of the captured image on the basis of a position of the estimated shadow region.

2. The mobile object control device according to claim 1, wherein the specific object is the mobile object, and
the recognition unit estimates the shadow region on the basis of the estimated self-position, the light source position, a shape of the mobile object, and a posture of a camera mounted on the mobile object.

3. The mobile object control device according to claim 1, wherein the specific object is a user whom the mobile object is guiding or following, and
the recognition unit estimates the shadow region on the basis of the estimated self-position, the light source position, a shape of the user, and a posture of a camera mounted on the mobile object.

4. The mobile object control device according to claim 1, wherein the recognition unit masks a portion of the captured image in a case where the mobile object is located outdoors.

5. The mobile object control device according to claim 1, wherein the recognition unit estimates an amount of movement of the mobile object on the basis of the captured image of which a portion is masked.

6. The mobile object control device according to claim 1, further comprising a map generation unit configured to generate map information on the basis of the captured image of which a portion is masked by the recognition unit,
wherein the generation unit generates the route on the basis of the map information generated by the map generation unit.

7. The mobile object control device according to claim 6, wherein the recognition unit estimates the self-position of the mobile object on the basis of the map information generated by the map generation unit and the captured image of which a portion is masked.

8. A method of controlling a mobile object causing a computer to:
estimate a self-position of a mobile object on the basis of a captured image including a surrounding situation of the mobile object and recognize a surrounding situation of the estimated self-position;
generate a route from the mobile object to a destination on the basis of the recognized surrounding situation and the destination;
control the mobile object so that the mobile object moves to the destination along the generated route; and
estimate a shadow region including a shadow of a specific object in the captured image on the basis of the estimated self-position and a light source position, and mask a portion of the captured image on the basis of a position of the estimated shadow region.

9. A computer readable non-transitory storage medium having a program stored therein, the program causing a computer to:
estimate a self-position of a mobile object on the basis of a captured image including a surrounding situation of the mobile object and recognize a surrounding situation of the estimated self-position;
generate a route from the mobile object to a destination on the basis of the recognized surrounding situation and the destination;
control the mobile object so that the mobile object moves to the destination along the generated route; and
estimate a shadow region including a shadow of a specific object in the captured image on the basis of the estimated self-position and a light source position, and mask a portion of the captured image on the basis of a position of the estimated shadow region.
